(19) United States
(12) Patent Application Publication
(10) Pub. No.: US 2025/0313155 A1
(43) Pub. Date: Oct. 9, 2025

(54) VEHICLE FRONT STRUCTURE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/018,400

(22) Filed: Jan. 13, 2025

(30) Foreign Application Priority Data
Apr. 9, 2024 (JP) 2024-062891

(51) Int. Cl. B60R 5/02; B60S 1/50

(52) U.S. Cl. CPC B60R 5/02; B60S 1/50

(57) ABSTRACT

The vehicle front portion structure includes a tank disposed at a front portion of the vehicle and storing a cleaning liquid therein, a front luggage compartment disposed at the front portion of the vehicle, and a temperature adjustment unit capable of adjusting the temperature of both the cleaning liquid in the tank and the front luggage compartment.

### CROSS-REFERENCE TO RELATED APPLICATION

This application claims priority to Japanese Patent Application No. 2024-062891 filed on Apr. 9, 2024, incorporated herein by reference in its entirety.

### BACKGROUND

### 1. Technical Field

The present disclosure relates to a vehicle front part structure.

### 2. Description of Related Art

Japanese Unexamined Patent Application Publication No. 2005-029057 (JP 2005-029057 A) below discloses a structure in which a front trunk box is provided in a front compartment.

### SUMMARY

Meanwhile, some vehicles with specifications for cold climate areas are provided with temperature maintaining mechanisms to maintain temperatures inside tanks provided at vehicle front portions in order to prevent washing solutions inside the tanks from being frozen. On the other hand, in a vehicle with a front trunk box (front luggage compartment) mounted at a vehicle front portion as the vehicle described in JP 2005-029057 A, the front trunk box and other components disposed around the front trunk box such as the tank independently function without cooperating with each other. Therefore, there is room for improvement cooperation of functions.

The present disclosure was made in view of the above circumstances, and an object thereof is to provide a vehicle front structure capable of adjusting a temperature in a front luggage compartment without providing a temperature adjustment mechanism dedicated for the front luggage compartment.

A vehicle front structure according to a first aspect includes: a tank that is disposed at a vehicle front portion and stores a washing solution therein; a front luggage compartment that is disposed at the vehicle front portion; and a temperature adjustment unit that is able to adjust both temperatures of the washing solution in the tank and inside of the front luggage compartment.

In the vehicle front structure according to the first aspect, the temperature adjustment unit can adjust both the temperatures of the washing solution inside the tank disposed at the vehicle front portion and inside the front luggage compartment disposed at the vehicle front portion, and it is thus possible to adjust the temperature in the front luggage compartment without providing a temperature adjustment mechanism dedicated for the front luggage compartment.

In a vehicle front structure according to a second aspect, in the configuration according to the first aspect,
at least parts of a tank wall of the tank and a luggage compartment wall of the front luggage compartment are integrated or are caused to abut each other, and the temperature adjustment unit is disposed in a region including the integrated or abutting parts.

In the vehicle front structure according to the second aspect, at least parts of the tank wall of the tank and the luggage compartment wall of the front luggage compartment are integrated or are caused to abut each other, the temperature adjustment unit is disposed in the region including the integrated or abutting parts, and it is thus possible to efficiently adjust the temperatures inside the tank and inside the front luggage compartment by the temperature adjustment unit.

In a vehicle front structure according to a third aspect, in the configuration according to the second aspect, the tank wall on an upper side of the tank and the luggage compartment wall on a lower side of the front luggage compartment are integrated or are caused to abut each other.

In the vehicle front structure according to the third aspect, the tank wall on the upper side of the tank and the luggage compartment wall on the lower side of the front luggage compartment are integrated or are caused to abut each other, and it is thus possible to provide the front luggage compartment above the tank.

In a vehicle front structure according to a fourth aspect, in the configuration according to the second aspect, the tank wall of the tank on one side in a vehicle width direction and the luggage compartment wall of the front luggage compartment on the other side in the vehicle width direction are integrated or are caused to abut each other.

In the vehicle front structure according to the fourth aspect, the tank wall of the tank on the one side in the vehicle width direction and the luggage compartment wall of the front luggage compartment on the other side in the vehicle width direction are integrated or are caused to abut each other, and it is thus possible to provide the tank and the front luggage compartment in an aligned manner in the vehicle width direction.

In a vehicle front structure according to a fifth aspect, in the configuration according to the first aspect, the temperature adjustment unit is disposed between the tank and the front luggage compartment.

In the vehicle front structure according to the fifth aspect, the temperature adjustment unit is disposed between the tank and the front luggage compartment, and it is thus possible to adjust the temperatures in the tank and the front luggage compartment by the temperature adjustment unit even in an aspect in which the tank and the front luggage compartment do not abut each other.

As described above, the vehicle front structure according to the present disclosure has an excellent effect that it is possible to adjust the temperature in the front luggage compartment without providing a temperature adjustment mechanism dedicated for the front luggage compartment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a part of a vehicle front structure according to a first embodiment of the present disclosure;

FIG. 2 is a side cross-sectional view schematically illustrating a portion of the vehicle front structure of FIG. 1;

FIG. 3 is a side sectional view corresponding to FIG. 2 schematically showing a modification of the first embodiment of the present disclosure;

FIG. 4 is a side cross-sectional view corresponding to FIG. 2 schematically showing another modification of the first embodiment of the present disclosure;

FIG. 5 is a perspective view schematically showing a part of a vehicle front structure according to a second embodiment of the present disclosure;

FIG. 6 is a side view schematically illustrating a portion of the vehicle front structure of FIG. 5;

FIG. 7 is a front cross-sectional view schematically illustrating a portion of the vehicle front structure of FIG. 5;

FIG. 8 is a side cross-sectional view corresponding to FIG. 7 schematically showing a modification of the second embodiment of the present disclosure; and

FIG. 9 is a side sectional view corresponding to FIG. 7 schematically showing another modification of the second embodiment of the present disclosure.

### DETAILED DESCRIPTION OF EMBODIMENTS

### First Embodiment

A vehicle front structure 10 according to a first embodiment of the present disclosure will be described with reference to the drawings. Note that an arrow FR appropriately shown in the drawings indicates a front side in the vehicle front-rear direction, and an arrow UP indicates an upper side in the vehicle up-down direction. The arrow RH indicates the right side in the vehicle-width direction. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified. Further, since each drawing schematically shows the vehicle front structure 10, the shapes of the size, the angle, and the like may differ depending on the drawings.

Note that, unless otherwise specified in the specification, each element is not limited to one, and a plurality of elements may be present. In addition, in the drawings, substantially the same elements are denoted by the same reference numerals, and redundant description in the specification is omitted.

First, a vehicle 11 to which the vehicle front structure 10 according to the present embodiment is applied will be described. For example, the vehicle 11 includes a power unit including a motor, an engine, or the like as a drive source, and is a battery electric vehicle, a fuel cell electric vehicle, or the like that travels with power generated by the power unit.

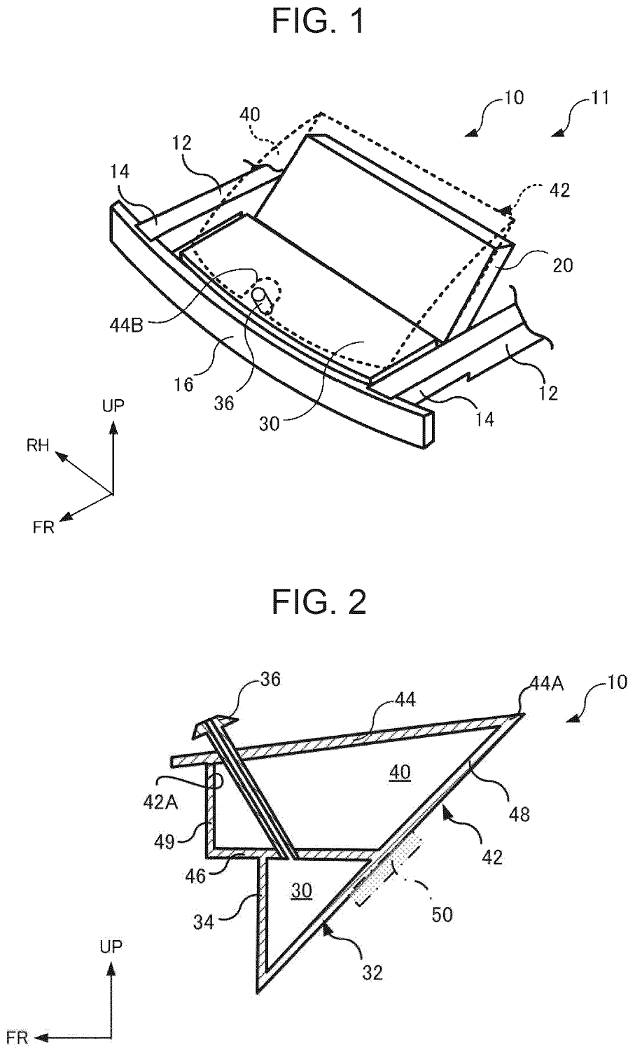

As shown in FIG. 1, the vehicle front structure 10 is provided with front side members 12 extending along the vehicle front-rear direction on both sides in the vehicle width direction. The front side members 12 are vehicle body skeleton members, and each have a substantially rectangular cross section along the vehicle width direction. At a front end portion of the front side member 12 in the vehicle front-rear direction, a crash box 14 that can be deformed when the vehicle collides is provided. In FIG. 1, the front side members 12 and the crash boxes 14 are integrated, but they may be separate components. Further, the rear portion side of the front side member 12 in the vehicle front-rear direction extends to the vehicle rear side via a kick portion (not shown) extending in an oblique direction toward the vehicle lower side.

A bumper reinforcement 16 as a bumper member extending along the vehicle width direction is disposed on the vehicle front side of the crash boxes 14, that is, on the front end portion of the vehicle front structure 10, and the left and right crash boxes 14 are connected by the bumper reinforcement 16. The bumper reinforcement 16 has a substantially rectangular cross section along the vehicle front-rear direction, and is formed in a curved shape such that a center portion in the vehicle width direction protrudes toward the vehicle front side.

A radiator 20 having a flat plate-like structure in the vehicle front-rear direction is disposed between the left and right front side members 12. The radiator 20 of the present embodiment is mounted in an inclined posture such that an end portion on the vehicle lower side protrudes toward the vehicle front side from an end portion on the vehicle upper side. Although not shown, a cylindrical fan shroud, an electric fan, and the like for guiding the air introduced from the radiator 20 to the vehicle rear side are disposed behind the radiator 20.

On the other hand, a tank 30 is provided in a space between the front side members 12 on both sides in the vehicle width direction and between the bumper reinforcement 16 on the vehicle front side and the radiator 20 on the vehicle rear side arranged along the vehicle width direction. The tank 30 is a tank in which a cleaning liquid for cleaning a windshield or the like is stored. A front luggage compartment (hereinafter referred to as a “frunk”) 40 is provided on the vehicle upper side of the tank 30. Note that the vehicle front structure 10 of the present embodiment is not provided with a power unit such as an engine, a motor, or the like as an example, and although not shown, the power unit is mounted below or behind the vehicle cabin.

As shown in FIGS. 1 and 2, the frunk 40 includes a rectangular box 42 constituting a cargo chamber, and an opening 42A is formed in an upper portion of the box 42. The box 42 is made of steel, resin, or the like. In the upper part of the opening 42A, a lid 44 that is openable and closable by a hinge 44A provided at the rear end is provided. As shown in FIG. 1, the lid 44 has, as an example, a curved surface along a hood (not shown) of the vehicle 11, and is formed of steel, resin, or the like in the same manner as the box 42.

In addition, a tank 30 is provided below the bottom wall 46, which is a luggage compartment wall on the lower side of the box 42. In the present embodiment, the tank box 32 forming the tank 30 is formed in a substantially triangular prism shape. In the present embodiment, as shown in FIG. 2, a rear wall 48, which is a rear-side cargo compartment wall forming the box 42 of the frunk 40, extends toward the tank 30 side, and the rear wall 48 serves as a rear-side tank wall forming the tank box 32 of the tank 30. The rear wall 48 is formed to be inclined in accordance with an inclination angle of the radiator 20 located behind the rear wall 48.

Further, in the present embodiment, as shown in FIG. 2, a part of the rear side of the bottom wall 46 forming the box 42 of the frunk 40 serves as an upper tank wall forming the tank box 32 of the tank 30. In the present embodiment, as an example, the tank wall 34 on the front side forming the tank box 32 is positioned on the vehicle rear side relative to the front wall 49 as the front side cargo compartment wall forming the box 42 of the frunk 40.

As shown in FIGS. 1 and 2, a bottom wall 46 as a tank wall, that is, a cleaning nozzle 36 formed in a pipe shape is provided on an upper surface of the bottom wall 46 facing the inside of the tank 30 on the vehicle rear side. The cleaning nozzle 36 is arranged such that a lower end portion thereof communicates with the inside of the tank 30, and is inclined so as to be positioned on the vehicle front side as it goes upward.

The lid 44 of the frunk 40 is formed with a cutout portion 44B through which the cleaning nozzle 36 is inserted, and the cleaning nozzle 36 passes through the inside of the frunk 40 and is discharged to the outside from the cutout portion 44B.

The rear wall 48, which is the cargo chamber wall of the frunk 40 and is also the tank wall of the tank 30, is provided with a temperature adjustment unit 50 capable of adjusting the temperature of both the cleaning liquid in the tank 30 and the inside of the frunk 40. The temperature adjustment unit 50 is, for example, an electric heater having a heat insulating function. The electric heater is a heater of a so-called resistance heating type that generates heat by utilizing Joule heat generated in the electric heating wire in accordance with the energization, and a known technique can be used. Note that the temperature adjustment unit 50 is not limited to an electric heater, and any structure may be used as long as it has a heat insulating function.

Further, the temperature adjustment unit 50 is not limited to a device having a heat insulating function, and may be configured by a cooling device having a cooling function. In this case, the cooling device may be configured by, for example, having a housing having a void inside, and arranging a refrigerant pipe in the void inside. In this case, the refrigerant pipe may be circulated with the radiator 20 as an example. Furthermore, both a heating device using a heater or the like and a cooling device using a radiator or the like may be provided.

The temperature adjustment unit 50 configured as described above is disposed on the rear surface of the rear wall 48 in a range opposed to both the inside of the frunk 40 and the inside of the tank 30.

### Operations and Effects

Next, the operation and effect of the first embodiment will be described.

In the vehicle front structure 10 according to the first embodiment, the temperature adjustment unit 50 can adjust the temperature of both the cleaning liquid in the tank 30 disposed in the vehicle front portion and the temperature in the frunk 40 disposed in the vehicle front portion. Therefore, the temperature of the frunk 40 can be adjusted without providing a temperature adjustment mechanism dedicated to the frunk 40. Conventionally, for example, in a vehicle of a cold district specification, there is a vehicle provided with a heat insulating mechanism for keeping the inside of the tank warm in order to prevent the cleaning liquid inside the tank provided in the front portion of the vehicle from freezing. In some cases, the vehicle 11 of the present embodiment is a vehicle using a cold value that requires a heat insulating mechanism for keeping the inside of the tank 30 warm. In this case, by using the heat insulation mechanism for the tank 30 as the temperature adjustment unit 50, the heat insulation mechanism can be shared between the tank 30 and the frunk 40.

Further, in the vehicle front structure 10 according to the first embodiment, the rear wall 48, which is a rear-side cargo compartment wall forming the box 42 of the frunk 40, extends toward the tank 30 side, and the rear wall 48 serves as a rear-side tank wall forming the tank box 32 of the tank 30. That is, at least a part of the tank wall forming the tank 30 and the luggage compartment wall forming the frunk 40 are integrated. Since the temperature adjustment unit 50 is disposed in a region including the integrated portion, the temperature adjustment unit 50 can efficiently adjust the temperature in the tank 30 and the inside of the frunk 40.

Further, in the vehicle front structure 10 according to the first embodiment, since the tank wall on the upper side of the tank 30 and the cargo chamber wall on the lower side of the frunk 40 are integrated as the bottom wall 46, the frunk 40 can be provided on the upper side of the tank 30.

In the first embodiment, at least a part of the tank wall forming the tank 30 and the cargo chamber wall forming the frunk 40 are integrated, but the present disclosure is not limited to this.

### Modification 1 of First Embodiment

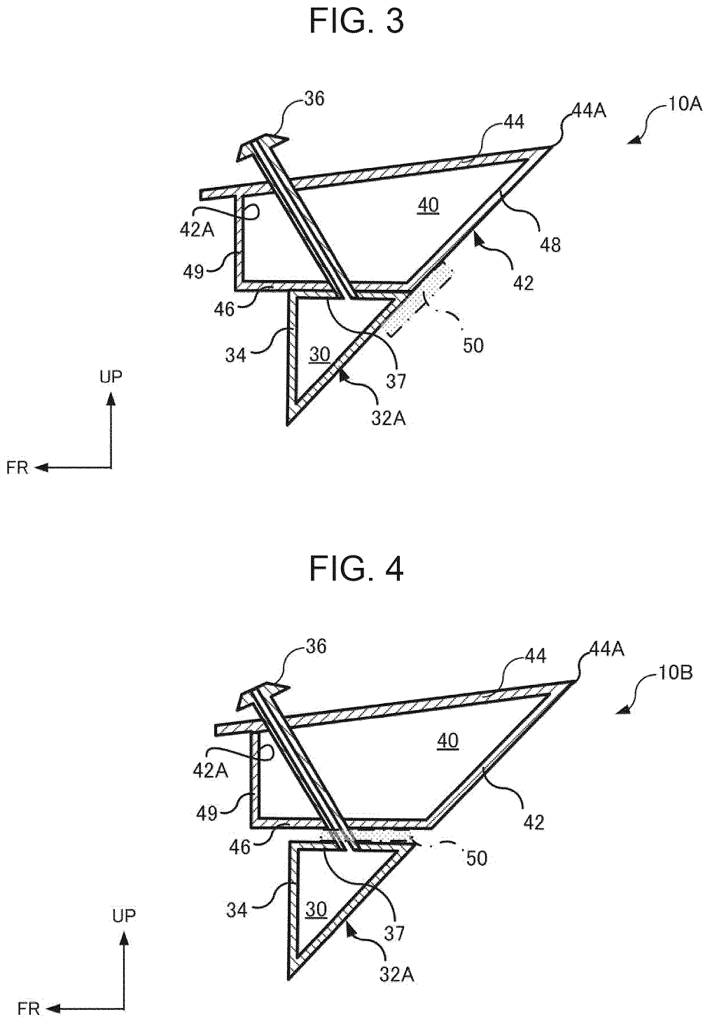

In the vehicle front structure 10A as the modification 1 of the above-described embodiment, at least a part of the tank wall forming the tank 30 and the cargo chamber wall forming the frunk 40 abut each other. Specifically, as shown in FIG. 3, the tank box 32A constituting the tank 30 includes an upper wall 37 separate from the bottom wall 46 of the frunk 40. As described above, even when the tank box 32A of the tank 30 and the box 42 of the frunk 40 are separate bodies, the temperature adjustment unit 50 can be disposed including a portion where the tank wall forming the tank 30 and the cargo chamber wall forming the frunk 40 abut each other. Therefore, the temperature adjustment by the temperature adjustment unit 50 can be efficiently performed as compared with a case where there is a gap between the tank 30 and the frunk 40.

### Modification 2 of First Embodiment

In the vehicle front structure 10B according to the second modification of the above-described embodiment, the temperature adjustment unit 50 is disposed between the tank 30 and the frunk 40. Specifically, as shown in FIG. 4, the tank box 32A constituting the tank 30 includes an upper wall 37 separate from the bottom wall 46 of the frunk 40, and the bottom wall 46 and the upper wall 37 are disposed with a gap therebetween. A temperature adjustment unit 50 is interposed between the bottom wall 46 and the upper wall 37. The temperature adjustment unit 50 may be provided on both the left side and the right side of the cleaning nozzle 36 in the vehicle width direction, or may be provided on only one side. In addition, a center portion in the vehicle width direction may be included in the vehicle rear side or the front side of the cleaning nozzle 36.

As described above, the tank box 32A of the tank 30 and the box 42 of the frunk 40 may be separate bodies, and the tank 30 and the frunk 40 may not be in contact with each other. Even in this case, the temperature of the tank 30 and the frunk 40 can be adjusted on both surfaces of the temperature adjustment unit 50 in the vertical direction.

### Second Embodiment

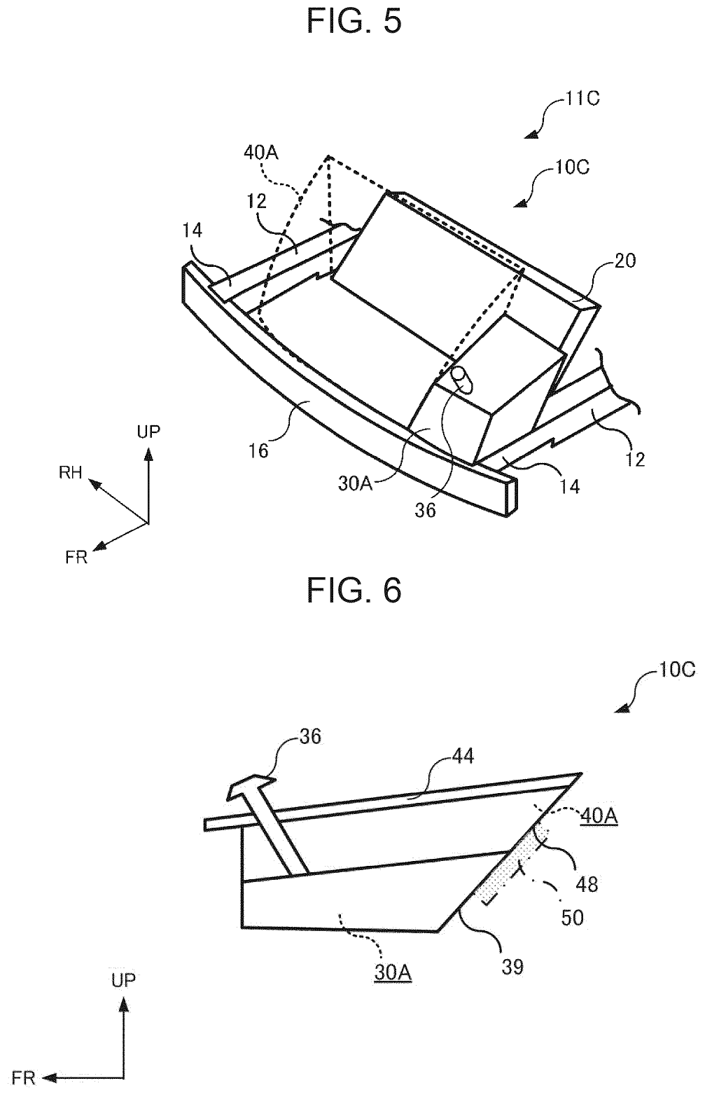

Next, a second embodiment of the vehicle front structure according to the present disclosure will be described with reference to FIGS. 5 to 7. Note that the same components as those in the first embodiment described above are denoted by the same reference numerals, and the description thereof will be omitted.

As shown in FIG. 5, in the vehicle front structure 10C, the tank 30A and the frunk 40A are arranged side by side in the vehicle width direction in a space between the front side members 12 on both sides in the vehicle width direction and between the bumper reinforcement 16 on the vehicle front side arranged along the vehicle width direction and the radiator 20 on the vehicle rear side. In the present embodiment, as an example, the frunk 40A in the vehicle breadth direction right side, and the tank 30A in the left side are cach deployed.

As shown in FIG. 6, the upper surface of the tank 30A is located below the lid 44 of the frunk 40A, and the rear wall 39 of the tank 30A and the rear wall 48 of the frunk 40A are inclined so as to be located on the same plane as in the above-described embodiment.

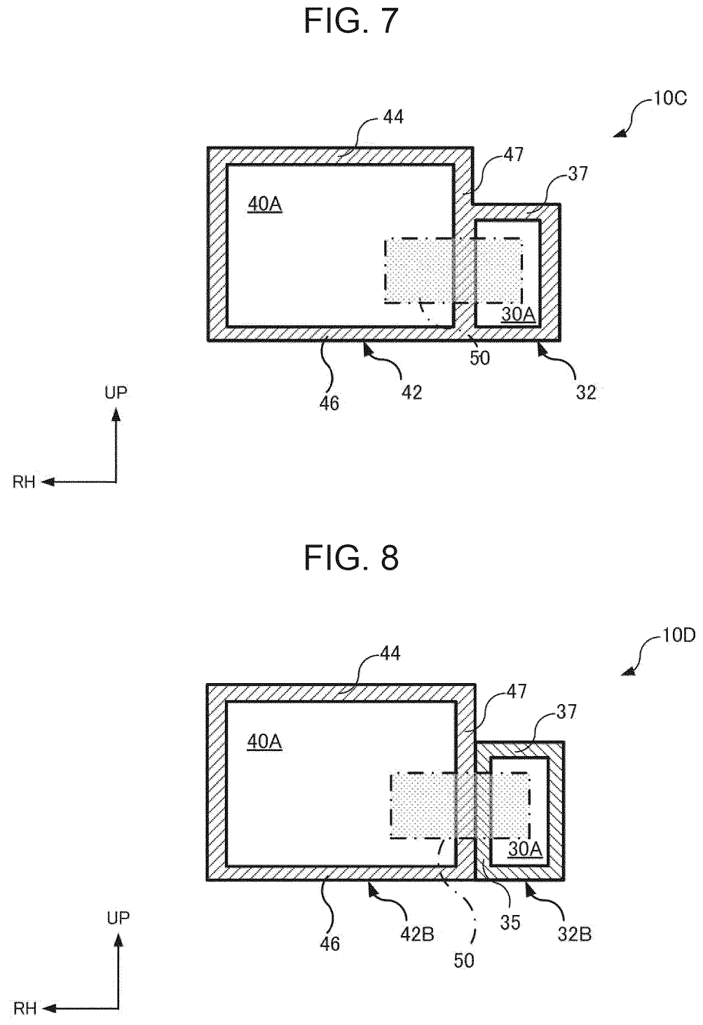

In addition, in the present embodiment, as shown in FIG. 7, a bottom wall 46, which is a lower luggage compartment wall forming the box 42 of the frunk 40A, extends toward the tank 30, and the bottom wall 46 serves as a lower tank wall forming the tank box 32 of the tank 30. Further, in the present embodiment, a part of the lower side of the left wall 47, which is the left cargo chamber wall forming the box 42 of the frunk 40, serves as the right tank wall forming the tank box 32 of the tank 30.

As shown in FIGS. 6 and 7, the temperature adjustment unit 50 is disposed in an area including both the rear wall 48 of the frunk 40A and the rear wall 39 of the tank 30A.

### Operations and Effects

Next, the operation and effect of the second embodiment will be described.

In the vehicle front structure 10C according to the second embodiment, a part of the lower side of the left wall 47, which is a left luggage compartment wall forming the box 42 of the frunk 40A, serves as a right tank wall forming the tank box 32 of the tank 30A. That is, at least a part of the tank wall forming the tank 30A and the luggage compartment wall forming the frunk 40A are integrated. Since the temperature adjustment unit 50 is disposed in an area including the integrated portion, the temperature adjustment unit 50 can efficiently adjust the temperature of the inside of the tank 30A and the inside of the frunk 40A.

Further, in the vehicle front structure 10C according to the second embodiment, since the tank wall on the right side of the tank 30 and the cargo chamber wall on the left side of the frunk 40 are integrated as the left wall 47, the frunk 40A can be provided on the right side of the tank 30A.

In the second embodiment, at least a part of the tank wall forming the tank 30A and the luggage compartment wall forming the frunk 40A are integrated, but the present disclosure is not limited thereto.

### Modification 1 of Second Embodiment

In the vehicle front structure 10D according to the second modification of the above-described embodiment, at least a part of the tank wall forming the tank 30A and the luggage compartment wall forming the frunk 40A abut each other. Specifically, as shown in FIG. 8, the tank box 32B constituting the tank 30A includes a right wall 35 separate from the left wall 47 of the frunk 40. As described above, the tank box 32B of the tank 30A and the box 42B of the frunk 40A may be separate bodies. Even in this case, the temperature adjustment unit 50 may be provided to include a portion where the tank wall forming the tank 30A and the load chamber wall forming the frunk 40A abut each other. Therefore, the temperature adjustment by the temperature adjustment unit 50 can be performed more efficiently than when there is a gap between the tank 30A and the frunk 40A.

### Modification 2 of Second Embodiment

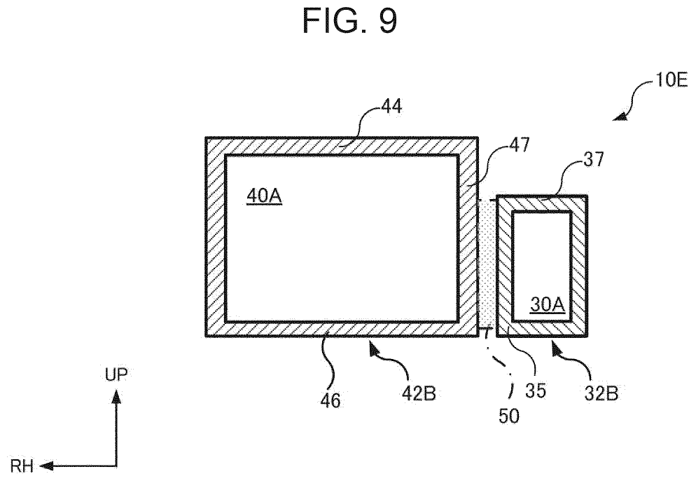

In the vehicle front structure 10E according to the second modification of the above-described embodiment, the temperature adjustment unit 50 is disposed between the tank 30A and the frunk 40A. Specifically, as shown in FIG. 9, the tank box 32B constituting the tank 30A includes a right wall 35 separate from the left wall 47 of the frunk 40A, and the left wall 47 and the right wall 35 are disposed with a gap. A temperature adjustment unit 50 is interposed between the left wall 47 and the right wall 35.

As described above, in some cases, the tank box 32B of the tank 30A is separate from the box 42B of the frunk 40A, and the tank 30A and the frunk 40A do not come into contact with each other. Even in this case, the temperature of the tank 30A and the frunk 40A can be adjusted on both the left and right sides of the temperature adjustment unit 50.

### Supplementary Explanation

In the above-described embodiment, the tank 30, 30A, the frunk 40, and 40A are shaped as described above, but the present disclosure is not limited thereto. The tank and the frunk may have any shape as long as the tank and the frunk have a space therein.

Further, in the second embodiment described above, the frunk 40A is disposed on the right side in the vehicle widthwise direction, and the tank 30A is disposed on the left side, but the present disclosure is not limited thereto. A frunk 40A may be disposed on the left side and a tank 30A may be disposed on the right side of the vehicle.

Further, the configuration of the temperature adjustment unit 50 is not limited to the above. For example, as in the second embodiment described above, there is a configuration in which the tank and the frunk are arranged in the vehicle width direction. In this configuration, a single pipe extending in the vehicle width direction may be provided on the vehicle front side of the tank and the frunk and on the rear side of the grille opening (not shown). In this case, a plurality of holes is provided along the longitudinal direction on the rear surface side of the pipe tube, and the refrigerant is discharged from the holes when the refrigerant flows into the pipe tube. As a result, the refrigerant discharged from the hole comes into contact with the tank and the frunk by the air flowing from the grille opening, and thereby the tank and the frunk are cooled. The refrigerant flowing into the pipe is circulated to the radiator 20 as an example.

Further, the configuration of the present disclosure is not limited to the above-described embodiment, and the configuration can be changed as appropriate as long as the problem can be solved.

What is claimed is:

1. A vehicle front structure comprising:
a tank that is disposed at a vehicle front portion and stores a washing solution therein;
a front luggage compartment that is disposed at the vehicle front portion; and
a temperature adjustment unit that is able to adjust both temperatures of the washing solution in the tank and inside of the front luggage compartment.

2. The vehicle front structure according to claim 1, wherein at least parts of a tank wall of the tank and a luggage compartment wall of the front luggage compartment are integrated or are caused to abut each other, and the temperature adjustment unit is disposed in a region including the integrated or abutting parts.

3. The vehicle front structure according to claim 2, wherein the tank wall on an upper side of the tank and the luggage compartment wall on a lower side of the front luggage compartment are integrated or are caused to abut each other.

4. The vehicle front structure according to claim 2, wherein the tank wall of the tank on one side in a vehicle width direction and the luggage compartment wall of the front luggage compartment on the other side in the vehicle width direction are integrated or are caused to abut each other.

5. The vehicle front structure according to claim 1, wherein the temperature adjustment unit is disposed between the tank and the front luggage compartment.
